(19) United States
(12) Patent Application Publication
(10) Pub. No.: US 2017/0046790 A1
(43) Pub. Date: Feb. 16, 2017

(54) Systems and Methods for Providing Indicators, Relevant to Transactions at Merchants

(71) Applicant: MASTERCARD INTERNATIONAL INCORPORATED, Purchase, NY (US)

(72) Inventors: Adam Axe, St. Louis, MO (US); Michael K. Forbis, St. Louis, MO (US)

(21) Appl. No.: 14/823,207

(22) Filed: Aug. 11, 2015

(51) Int. Cl. G06Q 40/00; G06F 3/0484; G06F 3/0482; G06F 3/0488

(52) U.S. Cl. CPC G06Q 40/12; G06F 3/0488; G06F 3/04842; G06F 3/0482

(57) ABSTRACT

Systems and methods for use in providing one or more indicators relevant to transactions to a merchant are disclosed. An exemplary method generally includes accessing, by a computing device, transaction data associated with a merchant, for a predefined interval and generating, by the computing device, an interface including at least one status indicator based on the accessed transaction data. The status indicator is representative of a value of a metric for the merchant during a first interval within the predefined interval relative to a value of the metric for the merchant during a second different interval within the predefined interval. The method then further includes causing the interface to be displayed at an output device of the computing device.

### FIELD

The present disclosure generally relates to systems and methods for providing indicators relevant to transactions at merchants.

### BACKGROUND

This section provides background information related to the present disclosure which is not necessarily prior art.

Merchants often offer products (e.g., goods and services, etc.) for sale to consumers. The products may be purchased through a variety of means, including, for example payment accounts. As part of the product purchases, via the payment accounts, by the consumers, data is transferred between different entities to authorize, settle and/or clear the transactions, i.e., transaction data. The transaction data is often stored, and subsequently used, for a variety of purposes, including marketing, business evaluation, etc.

### DRAWINGS

The drawings described herein are for illustrative purposes only of selected embodiments and not all possible implementations, and are not intended to limit the scope of the present disclosure.

FIG. 1 is an exemplary system for use in providing indicators relevant to transactions at a merchant;

FIG. 2 is a block diagram of an exemplary computing device, suitable for use in the system of FIG. 1;

FIG. 3 is a flowchart of an exemplary method for providing indicators relevant to transactions at a merchant, which can be implemented via the system of FIG. 1; and

FIGS. 4-10 are exemplary interfaces that may be displayed in connection with the system of FIG. 1 and/or the method of FIG. 3.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Transaction data is often compiled by payment networks, for example, in connection with payment device transactions by consumers. The transaction data may be aggregated, culled, divided, and/or analyzed in a number of different ways to gain insight into and/or awareness of various characteristics of the transactions, for merchants and/or consumers involved in the transactions. This insight and/or awareness is often provided, by payment networks, issuers, or others, in connection with various products offered to the merchants and/or consumers. The systems and methods herein can be used by the merchants or the consumers (broadly, users), to access transaction data related to their transactions, and view various characteristics represented by the transaction data. In particular herein, a dependent communication device is associated with a user, whereby indicators of transactions, in total and/or relative to transactions made in another interval, may be displayed, at the dependent communication device, to the user in a convenient and/or efficient manner. As such, by use of the dependent communication device, rather than viewing the data directly at an access communication device, the user, when a merchant, for example, is able to maintain an awareness of business performance, at the dependent communication device (which may be more readily accessible to the user than the access communication device), and respond accordingly.

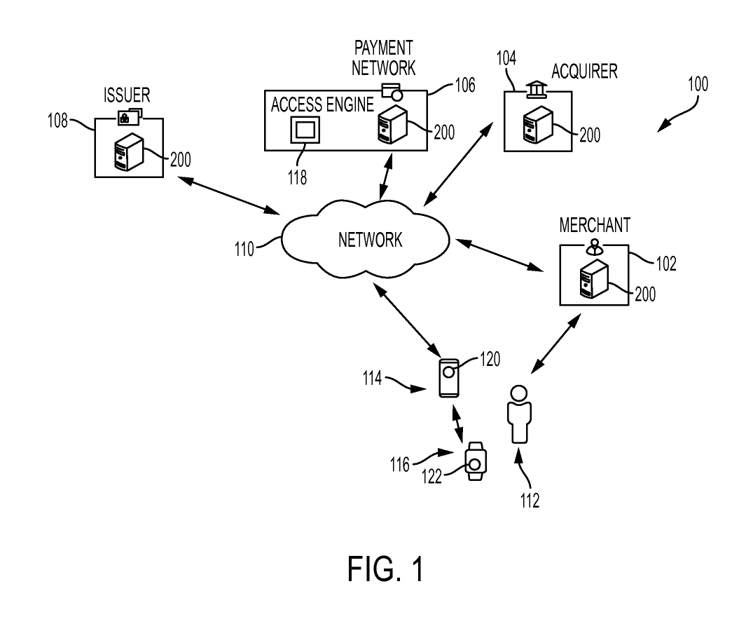

FIG. 1 illustrates an exemplary system 100, in which the one or more aspects of the present disclosure may be implemented. Although parts of the system 100 are presented in one arrangement, other embodiments may include the same or different parts arranged otherwise, depending, for example, on authorization processes for payment device transactions, communication between computing devices, etc.

The illustrated system 100 generally includes a merchant 102, an acquirer 104, a payment network 106, an issuer 108, and a user 112, each coupled to (or in communication with) network 110. In the illustrated system 100, the user 112 may include an individual associated with the merchant 102 such as an employee, a manager, an operator, and/or an owner, etc. However, in other exemplary embodiments, the user 112 may include an individual separate from the merchant, such as a consumer, etc.

The network 110 of the system 100 may include, without limitation, one or more local area networks (LAN), wide area networks (WAN) (e.g., the Internet, etc.), mobile networks, virtual networks, other networks as described herein, and/or other suitable public and/or private networks capable of supporting communication among two or more of the illustrated parts, or even combinations thereof. In one example, network 110 includes multiple networks, where different ones of the multiple networks are accessible to different ones of the illustrated parts in FIG. 1. In one example, the acquirer 104, the payment network 106, and the issuer 108 are connected via a private network for processing payment transactions, and the merchant 102 and the user 112 are connected through a public network, such as the Internet.

Generally in the system, the merchant 102, the acquirer 104, the payment network 106, and the issuer 108 cooperate, in response to a consumer (e.g., a purchase by the consumer), to complete a payment device transaction. In the exemplary embodiment, the consumer initiates the transaction by presenting a payment device, such as a credit card, a debit card, a pre-paid card, a payment token, a payment tag, a pass, another device used to provide an account number (e.g., a mobile phone, a tablet, etc.), etc., to the merchant 102.

In a payment account transaction by the consumer, for example, the merchant 102 reads the payment device (associated with the payment account) and communicates an account number and an amount of the purchase to the acquirer 104 through the network 110 to determine if the payment account is in good standing and if there is sufficient credit/funds to complete the transaction. The acquirer 104, in turn, communicates with the issuer 108, through the payment network 106, via the network 110, for authorization for the transaction. If the issuer 108 accepts the transaction, an authorization is provided back to the merchant 102 and the merchant 102 completes the transaction. The credit line or funds of the consumer, depending on the type of payment account, is then decreased by the amount of the purchase, and the charge is posted to the account associated with the payment device. The transaction is later cleared and settled by and between the merchant 102 and the acquirer 104 (in accordance with a settlement arrangement, etc.), and by and between the acquirer 104 and the issuer 108 (in accordance with another settlement arrangement, etc.). Certain accounts, such as debit payment accounts, may further include the use of a personal identification number (PIN) authorization and more rapid posting of the charge to the account associated with the card, etc.

Transaction data is generated, collected, and stored as part of the above interactions among the merchant 102, the acquirer 104, the payment network 106, the issuer 108, and the consumer. The transaction data represents at least a plurality of transactions, e.g., completed transactions, attempted transactions, etc. The transaction data, in this exemplary embodiment, is stored at least by the payment network 106 (e.g., in a data structure associated with the payment network 106, etc.). Additionally, or alternatively, the merchant 102, the acquirer 104, and/or the issuer 108 may store the transaction data, or part thereof, in a data structure. Or transaction data may be transmitted between entities of system 100, as used or needed. The transaction data includes, for example, payment account numbers, amounts of transactions, merchant IDs, merchant category codes, dates/times of transactions, products purchased and related descriptions or identifiers, products refunded, etc. It should be appreciated that more or less information related to transactions, as part of either authorization and/or clearing and/or settling, may be included in transaction data and stored within the system 100, at the merchant 102, the acquirer 104, the payment network 106, and/or the issuer 108. Further, transaction data, unrelated to a particular payment account, may be collected by a variety of techniques, and similarly stored within the system 100.

In various exemplary embodiments, consumers involved in the different transactions herein agree to legal terms associated with their payment accounts, for example, during enrollment in their accounts, etc. In so doing, the consumers may agree, for example, to allow merchants, issuers of the payment accounts, payment networks, etc., to use data collected during enrollment and/or collected in connection with processing the transactions, subsequently for one or more of the different purposes described herein.

While only one merchant 102, one acquirer 104, one payment network 106, one issuer 108, and one user 112 are illustrated in FIG. 1 (for ease of reference), it should be appreciated that a variety of other embodiments may include multiple ones of these entities, as well as multiple consumers, in various combinations and, in some of these embodiments, hundreds or thousands of certain ones of these entities.

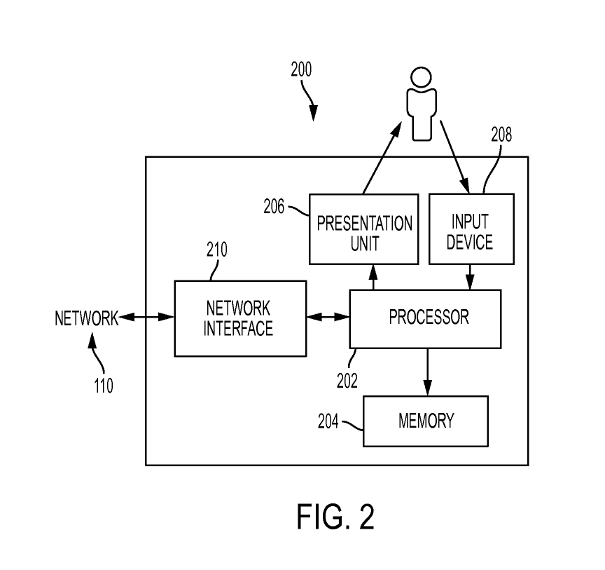

FIG. 2 illustrates an exemplary computing device 200 that can be used in the system 100. The computing device 200 may include, for example, one or more servers, workstations, personal computers, laptops, tablets, smartphones, watches, point of sale (POS) terminals, other suitable computing devices, etc. In addition, the computing device 200 may include a single computing device, or it may include multiple computing devices located in close proximity, or multiple computing devices distributed over a geographic region. However, the system 100 should not be considered to be limited to the computing device 200, as described below, as different computing devices and/or arrangements of computing devices may be used. In addition, different components and/or arrangements of components may be used in other computing devices.

In the exemplary embodiment of FIG. 1, each of the merchant 102, the acquirer 104, the payment network 106, and the issuer 108 are illustrated as including, or being implemented in, computing device 200, coupled to the network 110. The user 112 also is associated with both an access communication device 114 and a dependent communication device 116 both of which are consistent with computing device 200. The dependent communication device 116, as the name suggests, is dependent on data from and/or data accessed through the access communication device 114 (or companion communication device), for use as described herein. In one example, the access communication device 114 is a tablet or smartphone such as an iPad® or iPhone® device, or other portable communication device, and the dependent communication device 116 is a watch such as an Apple® watch device. Various other examples of portable devices may be included in other examples of the system 100 and/or other embodiments, for example, personal computers, etc. whereby the dependent communication device 116 relies, at least in part, on the access communication device 114 for receipt of and/or access to data, either stored within the device 114 or stored at and/or accessed from (or retrieved from) other entities, such as, for example, the payment network 106, the acquirer 104 and/or the issuer 108.

Referring to FIG. 2, the exemplary computing device 200 includes a processor 202 and a memory 204 coupled to (or in communication with) the processor 202. The processor 202 may include one or more processing units (e.g., in a multi-core configuration, etc.). For example, the processor 202 may include, without limitation, one or more processing units (e.g., in a multi-core configuration, etc.), including a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may include one or more data structures, and may further be configured to store, without limitation, transaction data generated as described herein, values, metrics, intervals, interfaces, indicators, data relating to other various calculations described herein, and/or other types of data suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. It should be appreciated that the memory 204 may include a variety of different memories, each implemented in one or more of the functions or processes described herein.

In the exemplary embodiment, the computing device 200 includes a presentation unit 206 (or output device or display device) that is coupled to the processor 202 (however, it should be appreciated that the computing device 200 could include output devices other than the presentation unit 206, etc.). The presentation unit 206 outputs information (e.g., background inquiries, etc.), either visually or audibly to a user, for example, the user 112 in the system 100, a consumer in the system 100, etc. It should be further appreciated that various interfaces (e.g., application interfaces, webpages, etc.) may be displayed at computing device 200, and in particular at presentation unit 206, to display information, such as, for example, transaction data, interfaces, indicators, other data as described herein, etc. The presentation unit 206 may include, without limitation, a liquid crystal display (LCD), a light-emitting diode (LED) display, an organic LED (OLED) display, an “electronic ink” display, etc. In some embodiments, presentation unit 206 includes multiple devices.

The computing device 200 also includes an input device 208 that receives inputs from the user of the computing device 200 (i.e., user inputs) such as, for example, selections of interfaces or buttons therein, swipe inputs, etc. The input device 208 is coupled to the processor 202 and may include, for example, a keyboard, a pointing device, a mouse, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both a presentation unit and an input device.

In addition, the illustrated computing device 200 also includes a network interface 210 coupled to the processor 202 and the memory 204. The network interface 210 may include, without limitation, a wired network adapter, a wireless network adapter, a mobile network adapter, or other device capable of communicating to one or more different networks, including the network 110. Further, in some exemplary embodiments, the computing device 200 includes the processor 202 and one or more network interfaces incorporated into or with the processor 202.

Referring again to FIG. 1, the system 100, and in particular, the payment network 106, includes an access engine 118. The communication devices 114 and 116 in the system also include access engines 120 and 122, respectively. The engine 118, as defined by executable instructions, is configured to provide a profile for the user 112, who is often associated with the merchant 102, or for another user associated with the merchant 102. The engine 118 is configured to access transaction data associated with the user 112, and in particular one or more accounts associated with the user 112 (based on the profile), provide access to the transaction data as appropriate, and/or compile values based on the transaction data for one or more metrics, for example, for the merchant 102, which may then be accessible by the engine 120 (or by the engine 122). Separately, the engines 120 and 122 are configured, in some embodiments, to compile values based on transaction data for one or more metrics. In general, access is provided between the various engines 118, 120, and/or 122 based on the appropriate credentials and/or security, for example, usernames, passwords, etc. of the user 112 or others.

Regardless of which of the engines 118, 120, and/or 122 compiles the values, per metric, the engine 122 is configured, as defined by executable instructions, to generate one or more interfaces in which the compiled values are displayed to the user 112. Often, the values will be displayed as one or more indicators within the interfaces, to provide an easily interpreted representation of the values and/or underlying transaction data. For example, an annular status indicator may be included in an interface as a representation of one or more particular values. In addition, the annular status indicator may further include particular colorings arranged in a particular order around the indicator, such as green-yellow-red, with the engine 122 causing transition to the appropriate color(s) around the indicator so that the appropriate color(s) (and corresponding value) are included/indicated in the interface (such that the interface is generally animated), and are displayed at the dependent communication device 116. It should be appreciated that a variety of different indicators may be employed in different interfaces to relay value(s) and/or transaction data to the user 112, with some using the same colors and/or shapes (and transitions between colors) as described herein and with some using different colors (or no colors), different transitions, or different shapes (or configurations).

Further in the system 100, the engine 122 may receive inputs, for example, from the user 112, etc. to permit the user 112 to navigate through one or more different interfaces (or through panels of a single interface) at the dependent communication device 116. Or, the interfaces may allow for the user 112, for example, to provide user preferences (to the engine 120 and/or the engine 122), which may be relied upon to display certain interfaces, to provide interfaces in a particular order, to include particular values in interfaces, or to take particular actions, etc. As an example, the user 112 may select a button at an interface being displayed at the dependent communication device 116 that causes a receipt to be sent to a consumer, for example, when an invoice is paid, etc.

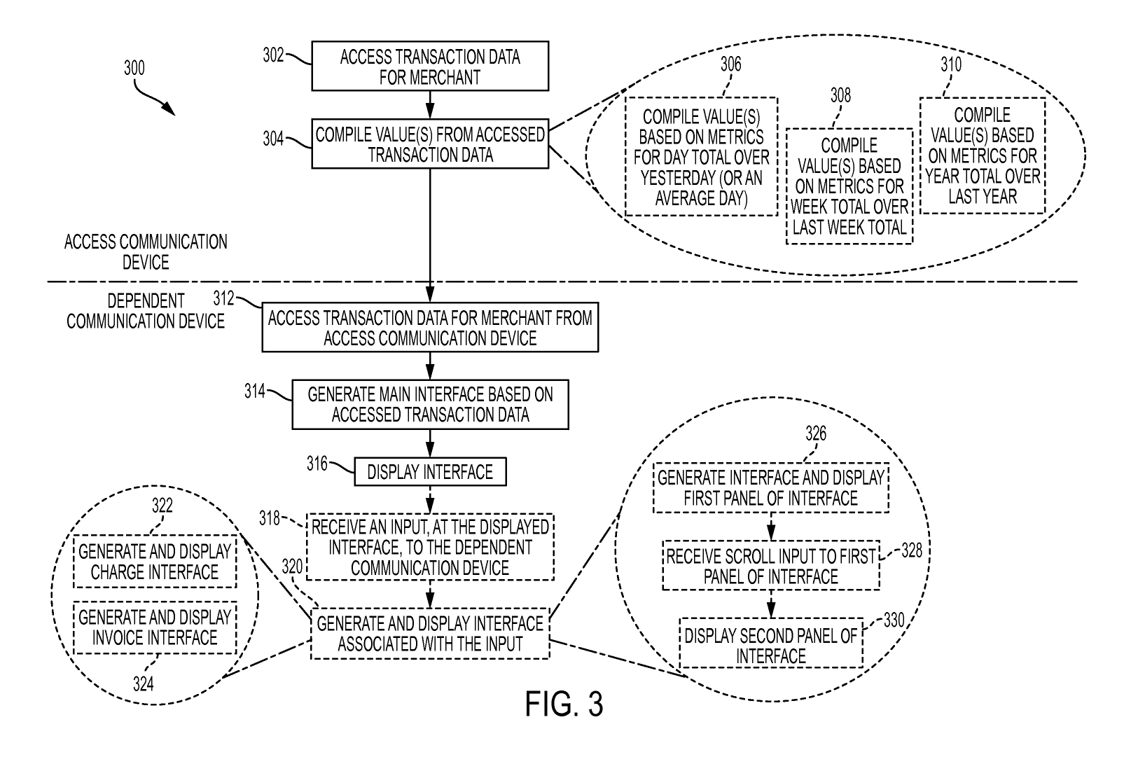

FIG. 3 illustrates an exemplary method 300 for providing an indicator relevant to transactions at a merchant. The exemplary method 300 is described as implemented in the dependent communication device 116 (e.g., in engine 122 thereof, etc.), which is associated with the user 112 who, in turn, is associated with merchant 102. However, the method 300 is not limited to the dependent communication device 116 and, as such, may be implemented in other parts of the system 100 (e.g., in the access communication device 114, in other computing devices 200, etc.), or in other systems. Further, for purposes of illustration, the exemplary method 300 is described herein with reference to the computing device 200. However, the methods herein should not be understood to be limited to the exemplary system 100 or the exemplary computing device 200, and the systems and the computing devices herein should not be understood to be limited to the exemplary method 300.

In the illustrated method 300, the access communication device 114, and particularly the engine 120 thereof, initially accesses transaction data for the merchant 102 from the payment network 106, at 302 (through access engine 118). The transaction data may include any desired transaction data associated with the merchant 102. For example, the access communication device 114 may access all available transaction data (in one or more accounts) for the merchant 102 from the payment network 106. Or, the access communication device 114 may only access transaction data for a particular interval (e.g., the last week, the last year, etc.), specified by the user 112, by the payment network 106, or by default(s) in the engine 118, etc. In some embodiments, the access communication device 114 may subsequently access transaction data from the payment network 106 to update the data associated with further steps described herein. The data access may be done continuously, or periodically at desired intervals. Further, in some embodiments, the user 112 may specify the particular transaction data to be accessed, for example, by account, by transaction type, by product, or by the particular interval for which the transaction data is to be accessed, for example, in connection with registering with the payment network 106 for the data (or for an engine (e.g., engine 120 and/or engine 122, etc.) provided by the payment network 106 for use to process the data as described herein), or as particular setting feature(s) associated with the engine 120 of the access communication device 114, etc.

Upon accessing the transaction data, the access communication device 114 compiles one or more values for one or more metrics, at 304, based on the accessed transaction data for the merchant 102. In particular, values are compiled for different metrics, as representing transactions at the merchant 102. The values may include standards, averages, sums, calculations, totals, patterns, functions, curves, etc., and may be represented as dollar amounts (or other currency amounts), quantities, numbers, graphs, other images, etc. The metrics may include, for example, total payments to (or cleared transactions for) the merchant 102, payments to the merchant 102 within a predefined interval (e.g., daily payments, weekly payments, monthly payments, quarterly payments, annual payments, etc.), status of transactions by consumers at the merchant 102, chargers by consumers to the merchant 102, invoices generated by the merchant 102, earnings by the merchant 102, etc. As an example, total sales in U.S. dollars per day by the merchant 102 may be the metric, and $867.00 may be the associated value.

In various implementations of the method 300, compiling values for the one or more different metrics may optionally include (as indicated by the dotted lines in FIG. 3), compiling values of the same or different metrics based on differing intervals. For example, at 306, the access communication device 114 may compile a value based on a metric for the merchant 102 for the current day and compare it to (or cause it to be displayed in comparison to) a value for the same metric for a prior day (or to an average value for various prior days). At 308, the access communication device 114 may compile a value based on a metric for the merchant 102 for the current week and compare it to (or cause it to be displayed in comparison to) a value for the same metric for a prior week (or a to an average value for various prior weeks) (e.g., a total value for the transactions to date for this week in U.S. dollars versus a total value for all transactions last week in U.S. dollars (or other currency), a total number of transactions to date for this week verses a total number of transactions last week, etc.). At 310, the access communication device 114 may compile a value based on a metric for the merchant 102 for the current year and compare it to (or cause it to be displayed in comparison to) a value for the same metric for a prior year (or to an average value for prior years) (e.g., a total value for the transactions to date for this year (in U.S. dollars (or other currencies) as a percentage of the total value for transactions as of this date last year, a total number of transactions to date this year as a percentage of the total number of transactions as of this date last year, etc.).

It should be appreciated that values may be compiled for different metrics associated with the merchant 102 and/or different intervals in other embodiments, as desired or dictated by the particular use of the transaction data by the user 112 and/or dependent communication device 116, etc.

With continued reference to FIG. 3, the dependent communication device 116 accesses desired transaction data for the merchant 102 (and corresponding values for such transaction data) from (or through) the access communication device, at 312. Generally, the access communication device, via engine 120, preforms data retrieval and value calculations, while the dependent communication device 116 acts as a receptacle of the data and calculated values. However, it should be appreciated that in various embodiments, the dependent communication device 116, via the engine 122, may perform one or more of these operations.

The transaction data (and values) accessed by the dependent communication device 116 may be transaction data from the access communication device 114 (e.g., stored in memory 204 thereof, transferred thereto from the payment network 106, etc.), values compiled by the access communication device 114 (or compiled at the payment network 106), or a combination of transaction data and values, etc. The dependent communication device 116 may access all available transactions data and/or values from the access communication device 114, or it may include transaction data and/or values for a predefined interval, for example, one day, one week, one month, two months, one quarter, one year, etc., within the particular interval for the transaction data and/or values accessed by the access communication device 114. As with the access communication device 114, in some embodiments, the user 112 may specify the particular transaction data and/or value(s) to be accessed, for example, by account, by transaction type, by product, or by the particular interval for which the transaction data is to be accessed. This may be done by the user 112, for example, in connection with registering with the payment network 106 for the data (or for an engine (e.g., engine 120 and/or engine 122, etc.) provided by the payment network 106 for use to process the data as described herein), or as a particular setting feature(s) associated with the engine 122, etc.

In using the accessed transaction data (and/or values), the dependent communication device 116 generates a main interface (or causes an interface to be generated), at 314. The main interface may be generated, by the engine 122 (as implemented in processor 202), directly at the dependent communication device 116. More specifically, the engine 122 includes a main interface, which includes one or more indicators. Generating the interfaces, in this example, includes associating each of the values previously compiled for the different metrics with one or more of the indicators, such that when the interface is displayed, the indicators included therein are indicative of the compiled values for the particular metrics. For example, the main interface may include a status indicator associated with a total spend on transactions at the merchant 102 for today (i.e., an exemplary metric). Generating the interface then includes the engine 122 associating the compiled value for the metric (i.e., total spend for today), to the status indicator, such that when the main interface is displayed the status indicator is indicative of the total spend on transactions at the merchant 102 today (e.g., as a numerical representation of the total spend, as a graphical representation of the total spend, etc.). It should be appreciated that various different metrics may be indicated in the main interface, such that generating the interface includes associating multiple different values with multiple different indicators in the interface.

Alternatively, the main interface and corresponding indicators may be generated, at the access communication device 114, based on the transaction data and/or values accessed thereby, and/or values generated thereby. The interface and indicators may then be transmitted to the dependent communication device 116, via network 110.

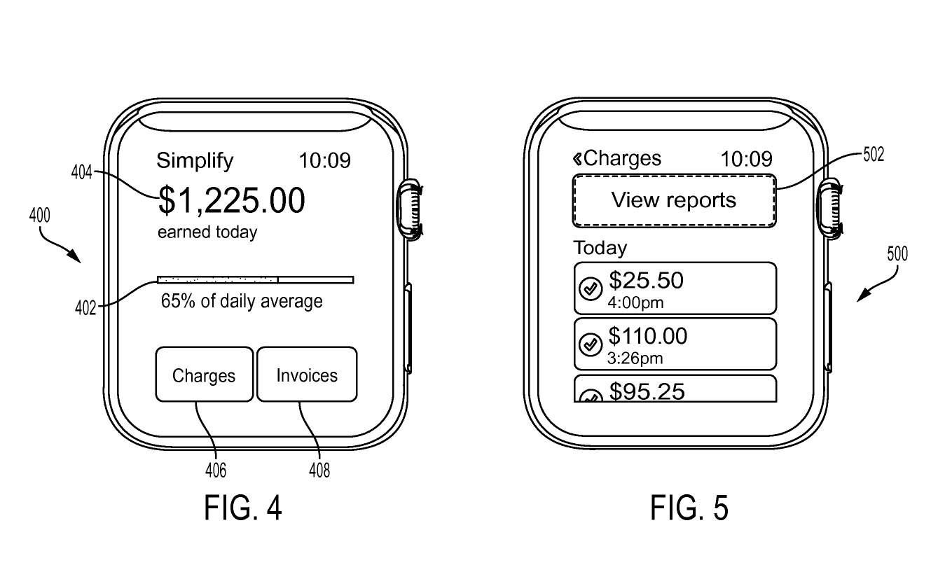

As can be appreciated, the main interface may include values for a variety of different metrics (each represented by one or more indicators), based on transactions data for the merchant 102, for example. As indicated above, metrics may include, for example, total payments to the merchant 102, payments to the merchant within a predefined interval (e.g., daily payments, weekly payments, monthly payments, quarterly payments, annual payments, etc.), status of transactions by consumers at the merchant 102, chargers by consumers to the merchant 102, invoices generated by the merchant 102, earnings by the merchant 102, etc. For example, main interface 400 described below with reference to FIG. 4 includes total daily sales as the metric. In various aspects, the values for the metrics identified at the main interface may be limited to desired or particular intervals, within the predefined interval for which the transaction data is initially accessed by the access communication device 114. In at least one embodiment, the metric(s) included in the main interface are user selectable, via engine 122 of dependent communication device 116 or via engine 120 of access communication device 114.

With further reference to FIG. 3, after the main interface is generated, the engine 122 displays the main interface at the presentation unit 206 of the dependent communication device 116, at 316.

In addition to the main interface, further interfaces (e.g., alternative interfaces, etc.) may also be displayed at the presentation unit 206 of the dependent communication device 116, for example, following input to the main interface or input to a subsequent interface. Each of the further interfaces is representative of generally the same, or in some cases different, transaction data as represented in the main interface. In method 300, the further interfaces are accessible, by the user 112, by providing one or more inputs to the dependent communication device 116, and in particular, the input device 208. Various buttons may be included at one or more of the interfaces (including the main interface) to allow the user 112 to navigate to and between the interfaces by providing the inputs to the buttons, as desired. The buttons may also allow the user 112 to initiate operations related to the particular data being displayed at the interfaces, for example, generating and transmitting a receipt to a consumer upon payment of an open invoice, initiating a refund to a consumer for a purchase, etc.

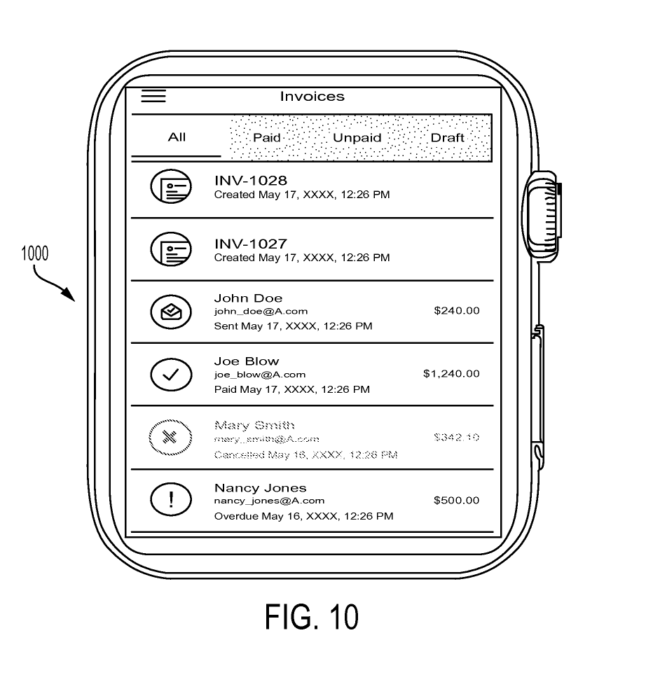

Upon user input to the input device 208 at a current interface (e.g., the main interface, etc.), the engine 122 receives the input at 318. Then, at 320, the dependent communication device 116, and in particular the engine 122, generates a further interface associated with the user input (in similar fashion to operation 314) and displays the interface at the presentation unit 206 of the dependent communication device 116 (in similar fashion to operation 316). For example, the engine 122 may optionally (as indicated by the broken lines) generate and display a charge interface, at 322, and an invoice interface, at 324, upon user input to the main interface. An exemplary charge interface 500 is described below with reference to FIG. 5. An exemplary invoice interface 1000 is described below with reference to FIG. 10.

Further, one or more of the interfaces generated by the engine 122 (or the engine 120, or the engine 118), when displayed at the presentation unit 206 of the dependent communication device 116, may not be wholly viewable. In particular, certain interfaces may include multiple panels, whereby the user 112 is able to view one panel of the interface at the presentation unit 206 and then view additional panels, as desired, by swiping the interface left or right. In this manner, several different variations of particular transaction data (or values compiled therefrom), or unrelated representations of transaction data, may be associated and/or displayed in a single interface, with the user 112 providing one or more swipe inputs to view all of the transaction data represented thereby in the single interface.

For example, in the method 300, in connection with operation 320, the engine 122 may optionally (as indicated by the broken lines) generate an interface having multiple panels and display a first panel of the interface, at 326, upon receipt of a user input to a prior interface (e.g., the main interface, the charge interface, the invoice interface, etc.). The engine 122, via input device 208, may then receive a swipe input to the first panel of the interface, at 328, and, in response, display a second panel of the interface, at the presentation unit 206, at 330. The engine 122, via input device 208, may then receive a swipe input to the second panel of the interface and, in response, display a third panel of the interface, at the presentation unit 206, and so on.

With that said, it should be appreciated that a variety of different interfaces and configurations of interfaces may be displayed, at the dependent communication device 116, based on various different inputs to one or more interfaces, as displayed by the engine 122. Further, a variety of different user inputs may be received at the different interfaces to cause the dependent communication device 116, via the engine 122, to take one or more different actions.

FIGS. 4-10 illustrate example interfaces that can be used at the dependent communication device 116, in connection with the method 300, to display various indicators indicative of values of various metrics for the merchant 102. In these examples, the dependent communication device is illustrated as a watch, with the interfaces displayed at the presentation unit 206 of the watch.

FIG. 4 illustrates an example main interface 400 that may be generated and displayed by the dependent communication device 116. The main interface 400 generally includes a total revenue indicator 404 (also generally a status indicator) for the merchant 102, and a status indicator 402 for the merchant's total revenue. The total revenue indicator is provided as a numerical value, in this example, and represents total revenue generated by the merchant 102 for the current day (broadly, a metric of the merchant 102). The status indicator 402 is provided as both a progressive bar and a percentage, in this example, and represents a comparison of the merchant's total revenue for the current day to an average daily revenue for the merchant 102 (broadly, a benchmark for the merchant 102). The progressive bar of the status indicator 402 transitions (or fills) (e.g., to the right in FIG. 4, etc.) as the corresponding percentage increases (such that the indicator 402 is generally animated). The average daily revenue may include an average revenue for all days the merchant 102 has been in operation, or an average revenue for each day within a specified time period, for example, as selected by the merchant 102, etc. The interface 400 also includes buttons 406 and 408 that can be selected by the user 112 to navigate to further interfaces described next.

FIG. 5 illustrates an example charge interface 500 that may be generated and displayed by the dependent communication device 116 upon selection of charge button 406 at the main interface 400. The charge interface 500 includes a listing of charges, or payment activity, to the merchant 102. Each charge includes an amount, a time, and a status indicator representing a status of the charge (e.g., pending, cleared, rejected, etc.). The charge interface 500 also includes a report button that can be selected by the user 112 to navigate to a further interface as described below. In some examples, charge interfaces may further include refund options/buttons associated with one or more charges listed therein, which upon selection by the user 112 cause the dependent communication device to generate and transmit a refund, or a refund notification, to the access communication device 114 and/or the identified consumer.

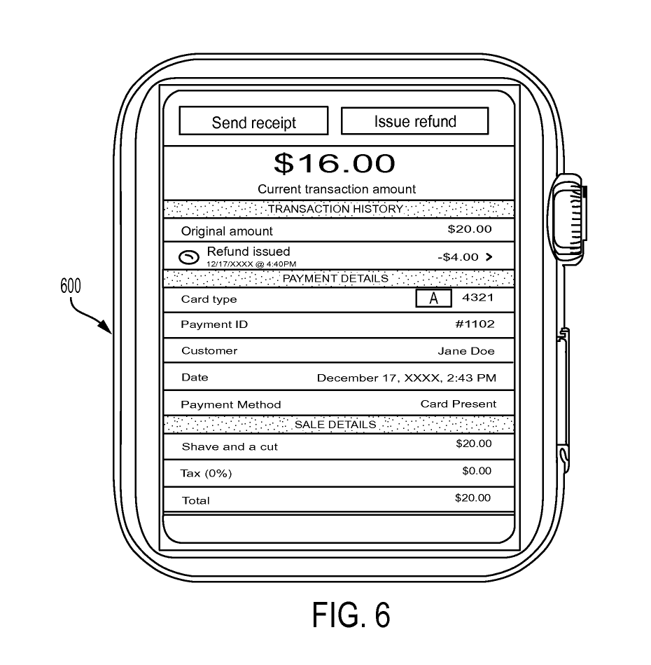

FIG. 6 illustrates an example charge detail interface 600 for a particular charge included in the charge interface 500. The charge detail interface 600 may be displayed, at the dependent communication device 116, upon selection, at the input device 208, of a particular charge in the listing of the charge interface 500. The charge detail interface identifies various details of the selected charge, and also includes buttons to send a receipt to the consumer or issue a refund, as appropriate. In some examples, these buttons may be included directly in the charge interface 500 so that such actions can be taken without necessarily navigating to the charge detail interface 600.

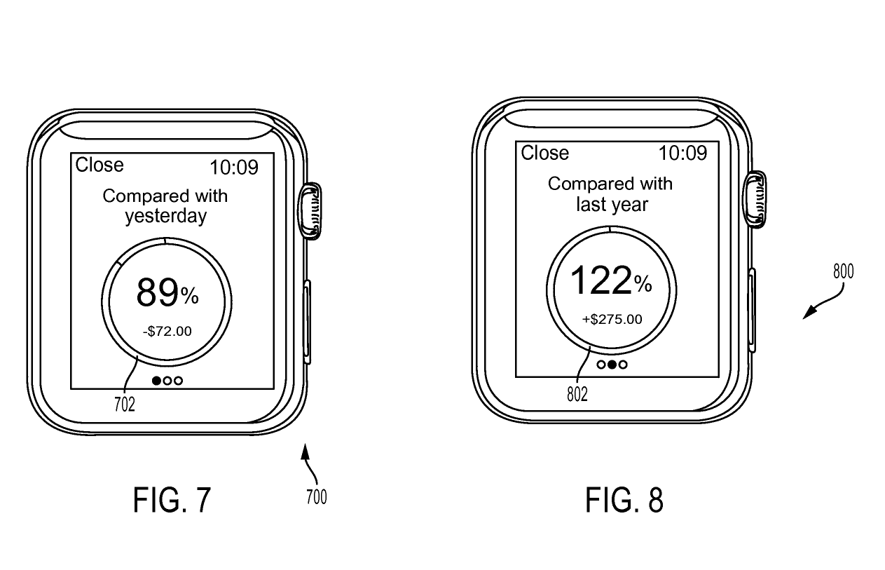

FIGS. 7 and 8 illustrate an example report interface displayed upon selection of report button 502 in the charge interface 500 of FIG. 5. The report interface, in this example, includes two panels, with a first panel 700 of the interface shown in FIG. 7 and a second panel 800 of the interface shown in FIG. 8. The first panel 700 includes a status indicator representing a comparison, as both a percentage, i.e., 89%, and as a dollar value, i.e., −$72.00, of the merchant's total revenue for the current day to total revenue for the prior day. The first panel 700 also includes an annular status indicator 702 as a further visual representation of the total revenue comparison. A filler transitions around the status indicator 702 as the comparison of the merchant's total revenue for the current day to total revenue for the prior day increases (such that the indicator 702 is generally animated). In this example, the annular status indicator 702 includes particular colorings arranged in order around the indicator 702, from red, to yellow, to orange, to green, with the engine 122 causing transition to the appropriate color(s) around the indicator 702 so that the appropriate color(s) (and corresponding values) are included/indicated in the interface at the indicator 702 based on the revenue comparison. The second panel 800 includes a similar status indicator representing a comparison, as both a percentage, i.e., 122%, and as a dollar value, i.e., +$275.00, of the merchant's total revenue for the current year to a total revenue for the prior year. The panel 800 also includes an annular status indicator 802, similar to indicator 702, that similarly illustrates a transition of fill (and/or color) around the indicator 802 as the revenue comparison increases.

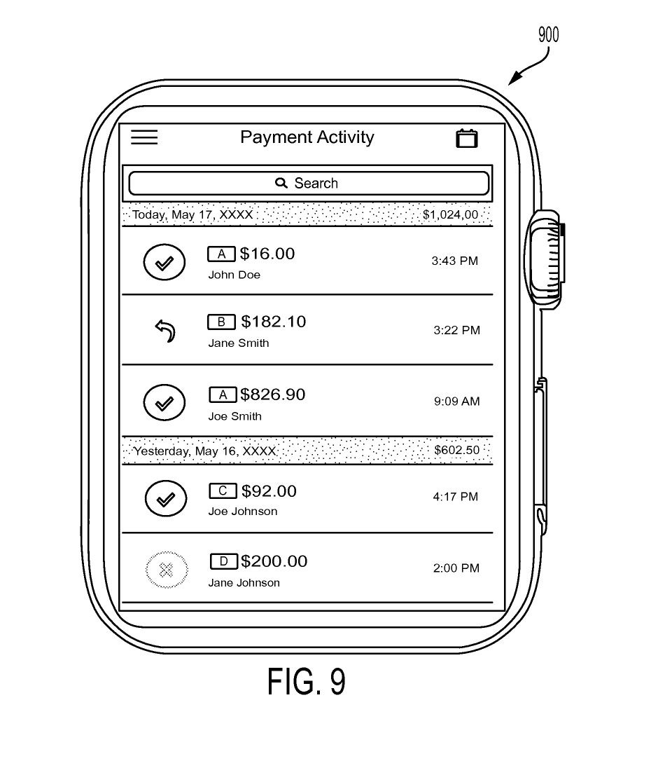

FIG. 9 illustrates another example charge interface 900 that may be generated and displayed by the dependent communication device 116 upon selection of charge button 406 at the main interface 400. Similar to the charge interface 500 of FIG. 5, the charge interface 900 includes a listing of charges, or payment activity, to the merchant 102. Each charge includes an amount, a time, a card type/brand, and a status indicator representing a status of the charge (e.g., approved as indicated by a checkmark, declined as indicated by an “X”, refunded as indicated by a curved arrow, etc.). In this example, the charge interface 900 also includes a search feature through which the user 112 can search for particular charges in the interface 900, etc.

FIG. 10 illustrates an example invoice interface 1000 that may be generated and displayed by the dependent communication device 116 upon selection of invoice button 408 at the main interface 400. The invoice interface 1000 includes a listing of invoices associated with the merchant 102. Each invoice includes an amount, a time, and a status indicator representing a status of the invoice (e.g., open as indicated by an envelope, paid as indicated by a checkmark, overdue as indicated by an exclamation point, etc.). The invoice interface 1000 also includes multiple tabs that provide further categorized views of the invoices in different panels, including those that are paid, those that are unpaid, and those that are in draft form. In addition, upon selection of one of the invoices in the listing, via input to the invoice interface 1000, additional details of the particular invoice are then shown at the presentation unit 206.

In other exemplary embodiments, the user 112 may include a consumer. The consumer may then access transaction data associated with his/her payment account(s) and use the systems and methods herein to provide indicators representing values for a variety of different metrics based on the transactions data. In this manner, the consumer can identify spending habits, behaviors, etc.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transforms a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) accessing, by a computing device, transaction data associated with a merchant, for a predefined interval; (b) generating, by the computing device, an interface including an indicator based on the accessed transaction data, where the indicator is representative of a value of a metric for the merchant during a first interval within the predefined interval relative to a value of the metric for the merchant during a second different interval within the predefined interval; and (c) causing the interface to be displayed at an output device of the computing device.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” “associated with,” “included with,” or “in communication with” another element or layer, it may be directly on, engaged, connected or coupled to, associated with, or in communication with the other element or layer, or intervening elements or layers may be present. As used herein, the term “and/or” includes any and all combinations of one or more of the associated listed items.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A portable dependent communication device comprising:
a display device;
a network interface for communicating with an access communication device; and
a processor in communication with the display device and the network interface, the processor configured to:
access transaction data for a merchant via the network interface, the transaction data associated with a predetermined interval;
generate an interface based on the accessed transaction data, the interface including an indicator related to a total revenue for the merchant for a current time interval compared to a total revenue for the merchant for a prior time interval, and colors included in the indicator based on a percentage of the total revenue for the merchant for the current time interval relative to the total revenue for the merchant for the prior time interval; and
display the interface at the display device.

2. The portable communication device of claim 1, further comprising an input device; and
wherein the processor is in communication with the input device and configured to display a first panel of an alternate interface at the display device in response to an input at the input device, the alternate interface including at least one indicator based on a week interval or a year interval, and the processor further configured to display a second panel of said alternate interface, at the display device, in response to a swipe input at the input device.

3. The portable communication device of claim 2, wherein the network interface and processor are integrated; and
wherein the display device and input device are integrated.

4. A system comprising the portable communication device of claim 1, and a separate communication device in communication with, via the network interface, the portable communication device;
wherein the processor of the portable communication device is configured to access the transaction data for the merchant from the separate communication device, which is configured to access the transaction data from a computing device associated with a payment network.

5. A non-transitory computer readable storage media including computer executable instructions that, when executed by at least one processor, cause the at least one processor to:
generate an interface based on transaction data for at least one merchant, the interface including a first panel and a second panel, the first panel including a status indicator related to a first metric, and the second panel including a status indicator related to a second metric; and
display the interface to a user.

6. The non-transitory computer readable storage media of claim 5, wherein the computer executable instructions, when executed by the at least one processor, further cause the at least one processor to access transaction data associated with the at least one merchant, for a predefined interval.

7. The non-transitory computer readable storage media of claim 6, wherein the computer executable instructions, when executed by the at least one processor, cause the at least one processor to access the transaction data associated with the at least one merchant from an access portable communication device, which in turn accesses the transaction data from a computing device associated with a payment network.

8. The non-transitory computer readable storage media of claim 5, wherein the first panel of the interface further includes an indicator indicating a difference between a value for the first metric for a current interval and a value for the first metric for a prior interval; and/or
wherein the second panel of the interface further includes an indicator indicating a difference between a value for the second metric for a current interval and a value for the second metric for a prior interval.

9. The non-transitory computer readable storage media of claim 5, wherein the computer executable instructions, when executed by the at least one processor, further cause the at least one processor to compile and display an invoice interface; and
wherein the invoice interface includes a listing of one or more invoices associated with the at least one merchant and a status indicator associated with each of the one or more invoices.

10. The non-transitory computer readable storage media of claim 9, wherein the computer executable instructions, when executed by the at least one processor, further cause the at least one processor to generate and display a charge interface, the charge interface including a listing of one or more charges to the at least one merchant and a refund option associated with each of the one or more charges.

11. The non-transitory computer readable storage media of claim 5, wherein the first metric is different than the second metric.

12. A computer-implemented method for use in providing one or more indicators relevant to transactions to a merchant, the method comprising:
accessing, by a computing device, transaction data associated with a merchant, for a predefined interval;
generating, by the computing device, an interface including an indicator based on the accessed transaction data, the indicator representative of a value of a metric for the merchant during a first interval within the predefined interval relative to a value of the metric for the merchant during a second different interval within the predefined interval; and
causing the interface to be displayed at an output device of the computing device.

13. The method of claim 12, wherein the interface further includes a total indicator related to the value of the metric for the merchant during the first interval.

14. The method of claim 12, wherein accessing the transaction data includes accessing the transaction data, by the computing device, from a companion portable communication device, which in turn accesses the transaction data from a computing device associated with a payment network.

15. The method of claim 14, wherein the computing device by which the transaction data is accessed includes a watch.

16. The method of claim 12, wherein the interface is a first interface; and
further comprising causing a second interface to be displayed at the output device, in response to a user input to the first interface.

17. The method of claim 16, wherein the second interface includes an invoice interface, the invoice interface including a listing of one or more invoices associated with the merchant and a status indicator associated with each of the one or more invoices.

18. The method of claim 17, further comprising causing details of one of the one or more invoices to be displayed at the output device, in response to a selection of said one of the one or more invoices.

19. The method of claim 16, wherein the second interface includes a charge interface, the charge interface including a listing of one or more charges to the merchant and a refund option associated with each of the one or more charges.

20. The method of claim 12, wherein the indicator is a first indicator and the metric is a first metric;
wherein the interface includes three panels, each accessible by a slide input to the computing device, the three panels including a first panel, a second panel, and a third panel;
wherein the first panel includes the first indicator;
wherein the second panel includes a second indicator representative of a value of a second metric for the merchant during a third interval within the predefined interval relative to a value of the second metric for the merchant during a fourth interval, different from the third interval, within the predefined interval;
wherein the third panel includes a third indicator representative of a value of a third metric for the merchant during a fifth interval within the predefined interval relative to a value of the third metric for the merchant during a sixth interval, different from the fifth interval, within the predefined interval; and
wherein causing the interface to be displayed includes displaying at least one of the first, second and third panels.
